(19) United States
(12) Patent Application Publication
(10) Pub. No.: US 2019/0308253 A1
(43) Pub. Date: Oct. 10, 2019

(54) MODULAR ROTARY CUTTING TOOL WITH CUTTING HEAD HAVING DRILLING/REAMING PORTIONS

(71) Applicant: Kennametal Inc., Latrobe, PA (US)

(72) Inventor: Li Ning, Pleasant Unity, PA (US)

(73) Assignee: Kennametal Inc., Latrobe, PA (US)

(21) Appl. No.: 15/949,545

(22) Filed: Apr. 10, 2018

(51) Int. Cl. B23B 51/02

(52) U.S. Cl. CPC B23B 51/02; B23B 2251/50

(57) ABSTRACT

A modular rotary cutting tool for conducting cutting operations on a work piece is described. The modular rotary cutting tool includes a tool shank having a pocket and a cutting head replaceably mounted in the pocket of the tool shank. The cutting head has a leading end and trailing end opposite the leading end. The drilling portion extends from the leading end of the modular rotary cutting tool to the reaming portion. The reaming portion extends from the drilling portion to a coupling portion of the cutting head. The coupling portion extends from the reaming portion to the trailing end of the cutting head.

### FIELD OF THE INVENTION

The invention relates in general to cutting tools, and in particular to a modular rotary cutting tool with a cutting head having a drilling portion and a reaming portion for performing both drilling and reaming cutting operations without the need to change cutting tools.

### BACKGROUND OF THE INVENTION

Modular rotary cutting tools, such as drills, and the like, having replaceable cutting tips mounted on shanks are known. The cutting heads and shanks display continuous and complementing configuration as fluted drills. To this end, each shank has a structure for retaining and rotating an associated cutting head. The associated cutting head has a complementing structure for being retained and rotated by the shank.

Typical cutting operations are conducted with a rotary cutting tool suitable for rough cutting, such as a drill, which removes large amounts of material from a workpiece, but leaves a relatively rough surface finish. Then, the roughly machined surface is machined again by another cutting tool configured to give the workpiece a finished cut, such as a reaming tool. However, such multiple cutting operations are time consuming and expensive because multiple cutting tools must be used to machine a single workpiece to a desired shape and operations must be periodically halted in order to replace the cutting tools for different cutting operations.

### SUMMARY OF THE INVENTION

The problem of reducing the number of cutting tools required to produce a workpiece with a finished cut is solved by providing a cutting tool that has both a drilling portion and a reaming portion on the same cutting tool. As a result, the customer needs fewer cutting tools, thereby reducing manufacturing time, while achieving good surface finish and hole size qualities.

In one aspect, a modular rotary cutting tool for conducting cutting operations on a work piece comprises a tool shank having a pocket; and a cutting head replaceably mounted in the pocket of the tool shank. The cutting head has a leading end and trailing end opposite the leading end. The cutting head further comprises a drilling portion and a reaming portion, wherein the drilling portion extends from the leading end of the modular rotary cutting tool to the reaming portion, and wherein the reaming portion extends from the drilling portion to a coupling portion of the cutting head.

In another aspect, a cutting head for a modular rotary cutting tool comprises a drilling portion and a reaming portion, wherein the drilling portion extends from the leading end of the modular rotary cutting tool to the reaming portion, and wherein the reaming portion extends from the drilling portion to a coupling portion of the cutting head.

In yet another aspect, a cutting head comprises a drilling portion and a reaming portion, wherein the drilling portion extends from the leading end of the modular rotary cutting tool to the reaming portion, and wherein the reaming portion extends from the drilling portion to a coupling portion of the cutting head. The drilling portion includes a main cutting edge, a leading conical surface, a drill rake face, a drill back taper and a drill margin land. The reaming portion includes a chamfer, a leading cutting edge, a reamer rake face, a margin land and a leading cutting edge relief surface.

These and other aspects of the present invention will be more fully understood following a review of this specification and drawings.

### BRIEF DESCRIPTION OF THE DRAWINGS

While various embodiments of the invention are illustrated, the embodiments shown should not be construed to limit the claims. It is anticipated that various changes and modifications may be made without departing from the scope of this invention.

FIG. 1 is a partial, exploded view of a modular drill according to an embodiment of the invention;

FIG. 2 is a side elevational view of an assembled modular drill according to an embodiment of the invention;

FIG. 3 is a top perspective view of the assembled modular drill of FIG. 2;

FIG. 4 is a top view of the assembled modular drill of FIG. 2;

FIG. 5 is a side elevational view of a cutting head with a drilling portion, a reaming portion and a coupling portion according to an embodiment of the invention;

FIG. 6 is another side elevational view of the cutting head of FIG. 5; and

FIG. 7 is top view of the cutting head of FIG. 5.

### DETAILED DESCRIPTION OF THE INVENTION

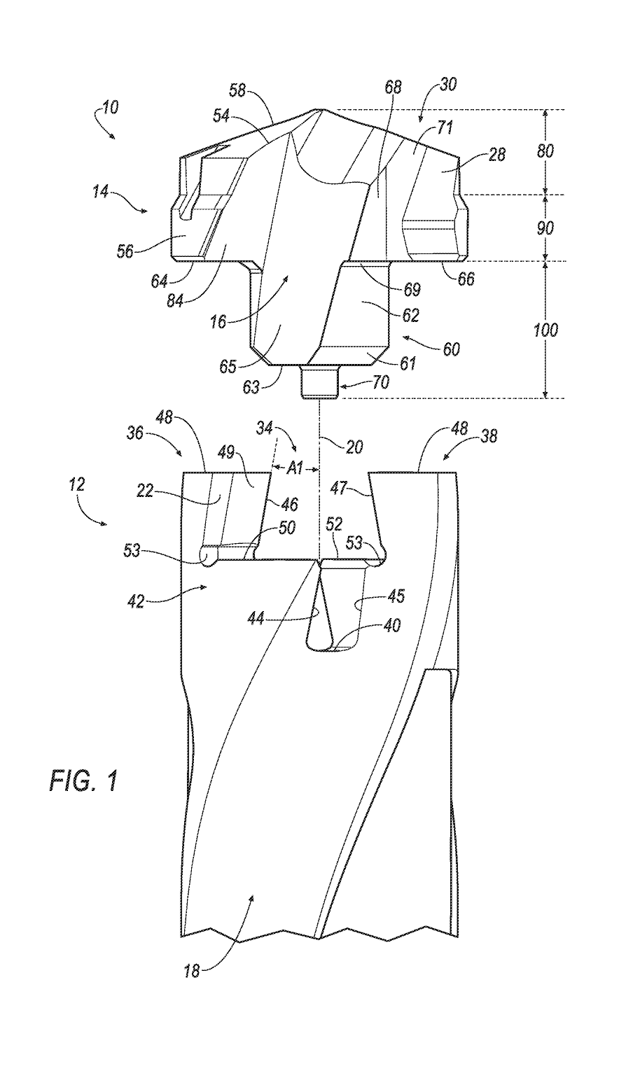

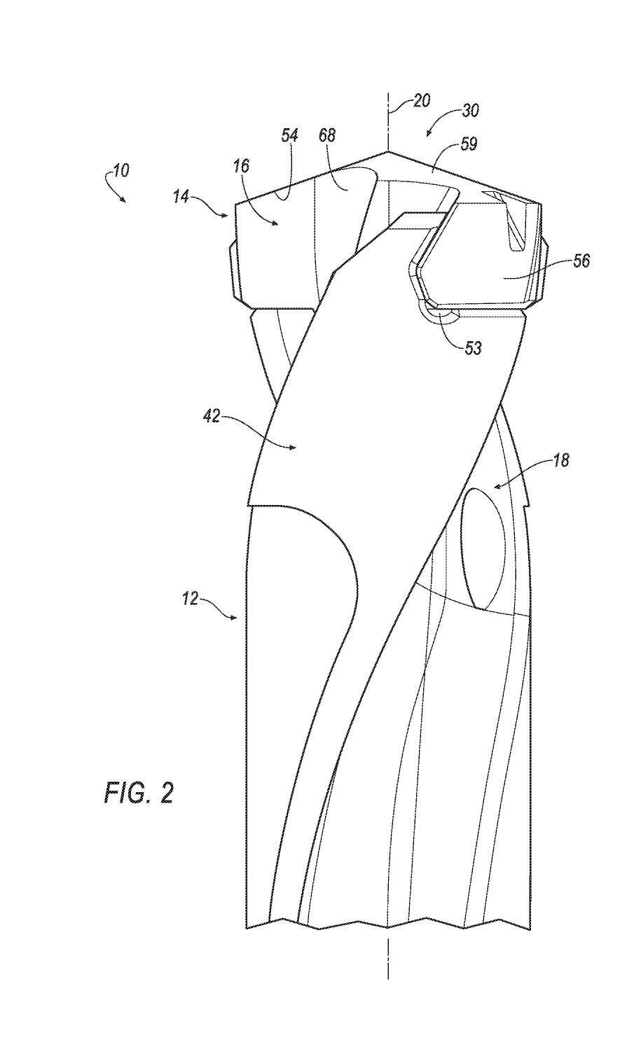

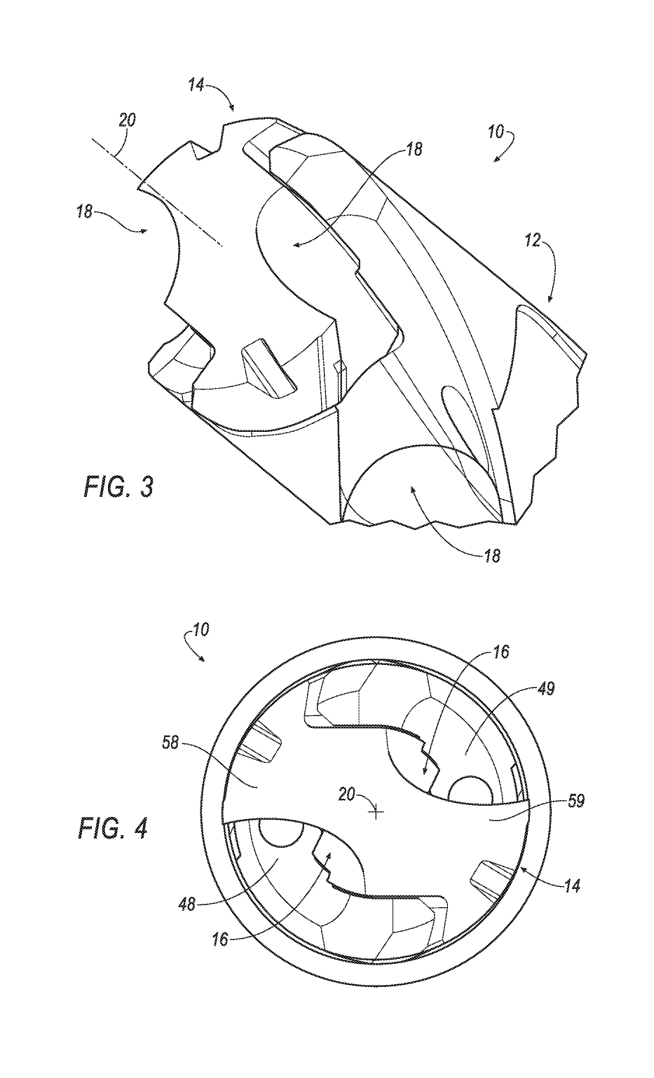

Referring now to FIGS. 1-3, a modular rotary cutting tool 10 for conducting rotary cutting operations on a work piece (not shown) is shown according to an embodiment of the invention. In general, the modular rotary cutting tool 10 includes a tool shank 12 and a replaceable cutting head 14, which is installed on and engages tool shank 12. In the illustrated embodiment, the modular rotary cutting tool 10 comprises a modular drill/reamer combination, having helical flutes disposed along the sides of the drill/reamer combination. However, the invention is not limited to use with a modular rotary drill cutting tool. The type of tool can also be, for example, a milling tool or another type of rotating tool, for example a reamer, a tap, or the like.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Throughout the text and the claims, use of the word “about” in relation to a range of values (e.g., “about 22 to 35 wt %”) is intended to modify both the high and low values recited, and reflects the penumbra of variation associated with measurement, significant figures, and interchangeability, all as understood by a person having ordinary skill in the art to which this invention pertains.

For purposes of this specification (other than in the operating examples), unless otherwise indicated, all numbers expressing quantities and ranges of ingredients, process conditions, etc are to be understood as modified in all instances by the term “about”. Accordingly, unless indicated to the contrary, the numerical parameters set forth in this specification and attached claims are approximations that can vary depending upon the desired results sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements including that found in the measuring instrument. Also, it should be understood that any numerical range recited herein is intended to include all sub-ranges subsumed therein. For example, a range of “1 to 10” is intended to include all sub-ranges between and including the recited minimum value of 1 and the recited maximum value of 10, i.e., a range having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

In the embodiment of FIGS. 1-4, two flutes are provided in diametric opposition to one another, only one flute being visible. The visible flute has a lateral recess forming part of a flute or cutting head flute portion 16 formed in cutting head 14. A corresponding or complementing lateral recess or shank flute portion 18 is formed in the shank 12. The depiction of FIG. 1 shows the cutting head 14 in a position for initially being installed on the shank 12. Installation of the cutting head 14 requires that the cutting head 14 be lowered into abutment or near abutment with the shank 12 and rotated in a direction opposite that of rotation during cutting operations. This installation procedure will both interlock the cutting head 14 with the shank 12 at certain respective mating peripheral surfaces in a manner precluding disengagement in the axial direction, taken with respect to a central, longitudinal axis 20, when the shank 12 is rotated by its associated cutting tool, such as a hand drill, drill press, machine tool, or the like (none shown).

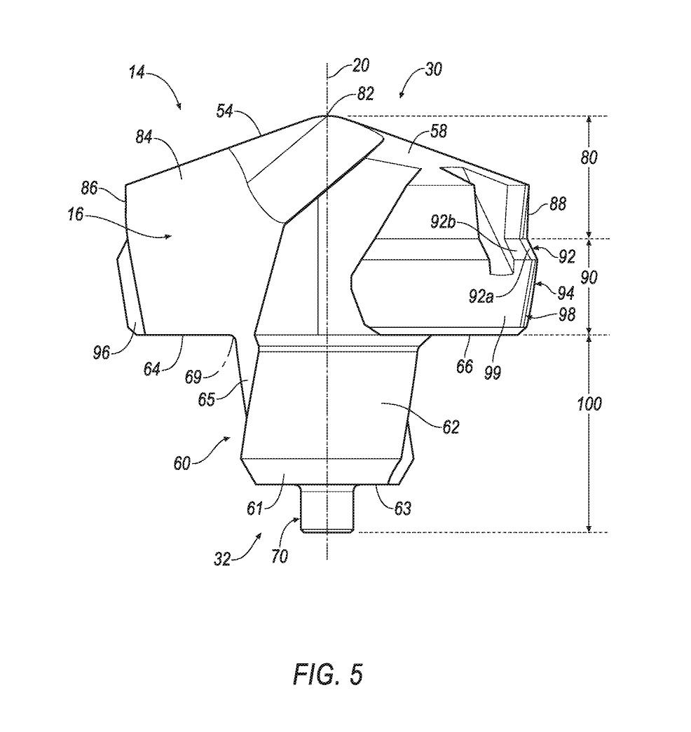

In addition, a threaded member (not shown) can be inserted through an axial aperture (not shown) in the shank 12 such that the threaded member can be threaded into a threaded hole (not shown) in the bottom of the cutting head 14 to securely hold the cutting head 14 in place. Further, a threaded member (not shown) can be inserted through a radial aperture (not shown) in the shank 12 such that threaded member can be threaded into the shank 12 and engage the cylindrical surface 62 of the cylindrical member 60 of the cutting head 12 (see FIG. 5) to securely hold the cutting head 12 in place. A notch or flat (not shown) may be necessary when engaging the cylindrical surface 62. In an alternate embodiment, the cylindrical member 60 can be omitted and the cutting head 12 can be pulled into the pocket by a differential screw (not shown).

Once the cutting head 14 is installed on the shank 12, the flute collectively formed by the cutting head flute portion 16 and the shank flute portion 18 will align to form a flute in generally continuous and undistorted fashion. A similar flute is of course formed on the other side of the cutting tool 10. Although two flutes are preferred, any number of flutes, including only one, is possible.

In the depiction of FIGS. 1-4, the cutting head flute portion 16 emerges at a leading end 30 of the cutting tool 10. The leading end 30 is defined for semantic purposes and is this end that engages a work piece (not shown) during a cutting operation. During cutting operations, the cutting tool 10 is mounted in the rotary cutting tool, rotated, and advanced progressively into the work piece (not shown) as cutting progresses. That end of cutting tool located oppositely leading end 30 is termed the trailing end 32 (see FIG. 5). The terms “leading end” and “trailing end” are semantic devices that apply equally to shank 12 and cutting head 14 as they connote directional orientation with respect to longitudinal and rotational axis 20 rather than specific structure. The leading end 30 is that which penetrates a work piece (not shown), and the trailing end 32 is that end opposed to the leading end 30.

The portion of the shank 12 that couples to and rotates the cutting head 14 is referred to as a pocket 34. The principal elements of pocket 34 include two generally symmetrical and similar castellated wall sections 36, 38. The wall section 36 will be described, it being understood that wall section 38 is a generally symmetrical counterpart thereof. Each wall section 36, 38 is essentially a continuation of the body of shank 12 that projects upwardly in the depiction of FIGS. 1-4 past a central floor portion 40 of the shank 12, along the outer periphery of shank 12. Each wall section 36, 38 has a smooth outer surface 42 that conforms to and is generally coextensive with the generally cylindrical outer surface of the cutting tool 10.

Each wall section 36, 38 has an internally facing, generally cylindrical surface 44, 45, a flat, vertically-angled retention surface 46, 47, and a radius blend 49, 51 extending between the vertically-angled retention surfaces 46, 47 and the driving surfaces 22, 24. The driving surface 24 is diametrically opposite driving surface 22 and is not shown in FIG. 1. The radius blend 51 is diametrically opposite radius blend 49 and is not shown in FIG. 1. The term “vertically-angled” is defined as being formed at a non-zero angle (i.e. non-parallel) with respect to the rotational axis 20 of the assembly 10. The angle, A1, of the retention surfaces 46, 47 can be between about five (5) degrees and about fifteen (15) degrees with respect to the rotational axis 20, as shown in FIG. 1. A radiused surface 41 may be located between the floor portion 40 and the surfaces 44, 45 to provide a smooth transition between the floor portion 40 and the surfaces 44, 45, thereby reducing stresses caused by the interference fit between the shank 12 and the cutting head 12 and forces exerted on the assembly 10 during machining operations. The term “interior” referring to those surfaces facing axis 20. It is noted that the vertically-angled retention surfaces 46, 47 of the shank 12 are closer to the rotation axis 20 than the driving surfaces 22, 24 (and the radius blends 49, 51) of the shank 12. In other words, the retention surfaces 46, 47 of the shank 12 are radially inward (i.e., closer to the rotational axis 20) with respect to the driving surfaces 22, 24 (and radius blends 49, 51) of the shank 12.

One advantage of the vertically-angled retention surfaces 46, 47 being flat is that stresses will be lower in the undercut region (adjacent to those walls) when compared for example to a conical surface when side loads (generally perpendicular to the retention surfaces) occur in the drilling process. Therefore, the pocket 34 has a higher reliability and cutting head 14 is more securely held in the shank 12 during machining operations. Another advantage of the retention surfaces 46, 47 being flat is that a larger cross section between the outer surface 42 and the retention walls 46, 47 can be achieved, allowing sufficient space for coolant holes 78 without sacrificing strength of the pocket 42. It is also noted that the driving surfaces 22, 24 are farthest from the rotational axis 20 than the radius blends 49, 51 and the vertically-angled retention surfaces 46, 47. The advantage of having the drive surfaces 22, 24 completely separated from the retention surfaces 46, 47 is that stresses caused by the machining operation will not occur in the same region of the undercut 53, and therefore the maximum stress value will be lower. Thus, a longer fatigue life can be achieved by lowering the stresses.

The driving surfaces 22, 24 can be vertical, on a plane parallel to axis 20, or angled forwardly. The optimum range for the angle, A2, formed between the driving surfaces 22, 24 and a vertical plane parallel to the rotational axis 20 is between about zero (0) degrees and about twenty (20) degrees.

Each wall section 36, 38 also has an upwardly facing upper face 48, an upwardly facing lower faces 50, 52 and an elliptically-shaped undercut 53 between the upwardly facing lower face 50 and the driving surfaces 22, 24, the retention surfaces 46, 47 and the radius blends 49, 51. The undercut 53 provides a continuous and smooth transition between the faces 50, 52 and the driving surfaces 22, 24, which allows for reduction of stresses caused by the torque. In addition, the undercut 53 provides clearance for the cutting head 14 when mounted on the shank 12.

The cutting head 14 has at least two main cutting edges (only the main cutting edge 54 is visible in FIG. 1), a peripheral generally cylindrical outer surface 56, and a leading conical surface 58 which conical surface 58 is of course interrupted or incomplete due to presence of the flutes.

Any or all of the central floor portion 40, and the upwardly facing lower faces 50, 52 of the shank 12 serve as abutment surfaces that abut the downwardly facing cutting head faces 64, 66 of the cutting head 14 when the cutting head 14 is installed on the shank 12.

The cutting head 14 has a shank connection portion opposite the cutting portion, or alternatively stated, facing the trailing end 32 of the cutting head 14, in the form of an interlocking member arranged to retain the cutting head 14 within the pocket 34 of the shank 12. In the embodiment of FIGS. 1-4, this interlocking member comprises a generally cylindrical member 60, which is located centrally along rotational axis 20 and an optional coupling pin 70. In some embodiments, the coupling pin 70 can be omitted.

The cylindrical member 60 is so-called due to its characteristic cylindrical surface 62 arranged substantially parallel to the rotational axis 20. The cylindrical member 60 provides an interlocking member corresponding to and engaging the pocket 34, which the pocket 34 serves as an interlocking member of the shank 12. The cylindrical surface 62 cooperates with the cylindrical surfaces 44, 45 to provide an interference fit therebetween, and to accurately center the cutting head 14 with respect to the rotational axis 20 of the assembly 10. The cylindrical member 60 includes a chamfer 61 extending between the cylindrical surface 62 and an end surface 63 of the cylindrical member 60. The chamfer 61 provides clearance for the cutting head 14 when mounted onto the shank 12. The cylindrical member 60 also includes a lateral recess 65 that modifies the cylindrical surface 62 and forms a portion of the cutting head flute portion 16 when the cutting head 14 is mounted onto the shank 12. A chamfered surface 69 may be located between the cylindrical surface 62 and the faces 64, 66 to provide a smooth transition and resistance to cracks.

Surrounding the cylindrical member 60 is the cutting head faces 64, 66, which face downwardly in the depiction of FIG. 1. It should be understood at this point that cutting head 14 is generally bilaterally symmetrical, so that cutting head face 64 is generally a mirror image of cutting head face 66. In those embodiments where there may be three flutes, for example, there will accordingly be three, rather than two, similar cutting head faces corresponding to cutting faces 64, 66 disposed about the periphery of the cutting head 14.

The downward facing cutting head faces 64, 66 may be stepped, angled, or located at different levels or points along axis 20, in the same manner as and to correspond to the axial spacing apart of the faces 48, 50 of the shank 12. Any or all of the faces 64, 66 serve as abutment surfaces for abutting corresponding faces 48, 50 of the shank 12. The abutment of the faces 64, 66 with their corresponding faces 48, 50 of the shank 12 seats the cutting head 14 on the shank 12 responsive to compressive axial loading.

The cutting head 14 also includes vertically-angled retention surface 68 that cooperates with the vertically-angled retention surfaces 46, 47 of the shank 12, and a radius blend 71 between the vertically-angled retention surface 68 and the driven surfaces 26, 28, respectively. The term “vertically-angled” is defined as being formed at a non-zero angle (i.e. non-parallel) with respect to the rotational axis 20 of the assembly 10. When rotated into the interlocked position with respect to pocket 34, the retention surface 68 of the cutting head 14 cooperates with a respective vertically-angled retention surface 46, 47 of the pocket 34, thereby preventing disengagement of the cutting head 14 in the axial direction away from the shank 12. It is noted that the retention surface 68 of the cutting head 14 are closer to the rotational axis 20 than the driven surfaces 26, 28. In other words, the retention surface 68 of the cutting head 14 are radially inward (i.e., closer to the rotational axis 20) with respect to the driven surfaces 26, 28.

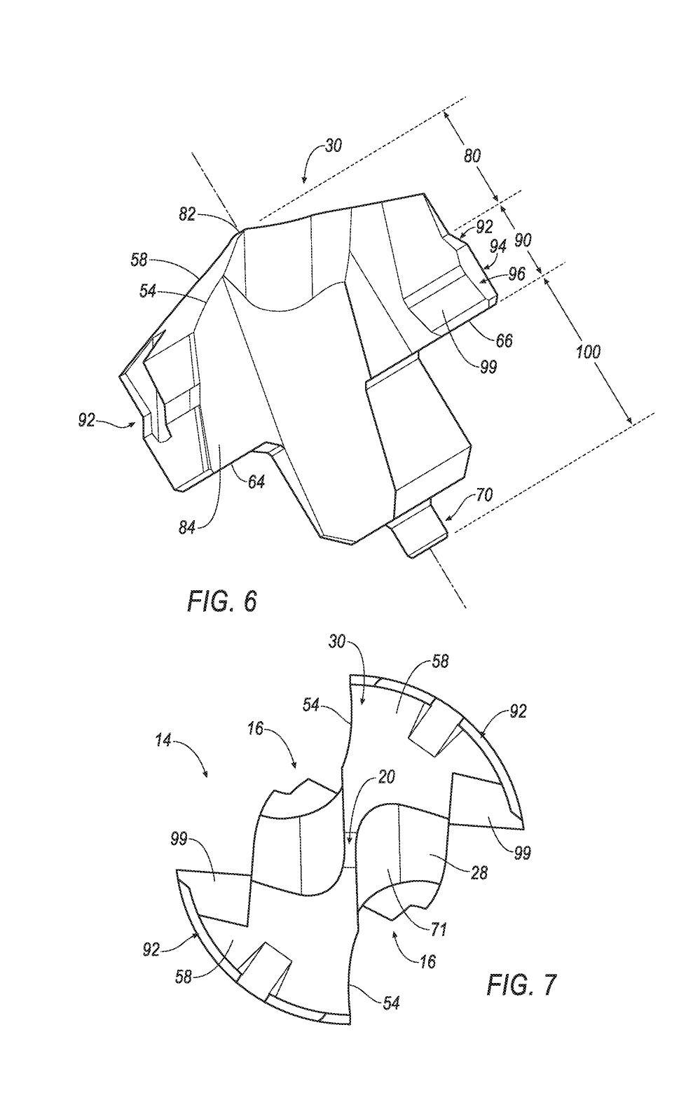

Referring now to FIGS. 5-7, one aspect of the invention is that the cutting head 14 has three distinct portions: 1) a drilling portion, designated generally at 80; 2) a reaming portion, designated generally at 90; and 3) a coupling portion, designated generally at 100. It is noted that the reaming portion 90 is located between the drilling portion 80 and the coupling portion 100. The drilling and reaming portions enable the cutting head 14 to perform simultaneously both a drilling and reaming cutting operations without the need to change the type of cutting tool, thereby providing a cost savings to the consumer.

The drilling portion 80 is located at the leading end 30 of the cutting head 14 and extends from a cutting tip 82 to the reaming portion 90. The drilling portion 80 includes the main cutting edge 54 and the leading conical surface 58. In addition, the drilling portion 80 includes a drill rake face 84, a drill back taper 86 and a drill margin land 88.

The reaming portion 90 extends from the drilling portion 80 to the coupling portion 100. The reaming portion 90 includes a chamfer 92 that can be formed at an angle of between about 15 degrees to about 80 degrees with respect to the longitudinal axis 20. The chamfer 92 includes a chamfer primary relief surface 92a, and a chamfer secondary relief surface 92b. The chamfer primary relief surface 92a can be formed at an angle of between about 3 degrees to about 10 degrees with respect to a plane that is perpendicular to the longitudinal axis 20. The chamfer secondary relief surface 92b can be formed at an angle of between about 12 to about 25 degrees with respect to a plane that is perpendicular to the longitudinal axis 20. In the illustrated embodiment, the chamfer 92 comprises a single chamfer. However, the invention can be practiced with the chamfer 92 comprising a double chamfer. A radius blend (not shown) can be formed between the chamfer 92 and a leading cutting edge 94. The leading cutting edge 94 can be formed with a back taper with respect to the longitudinal axis 20. The reaming portion 90 also includes a reamer rake face 96, a margin land 98 and a leading cutting edge relief surface 99.

The coupling portion 100 extends from the reaming portion 90 to the trailing end 32 and includes the cylindrical member 60, the chamfer 61 extending between the cylindrical surface 62 and the end surface 63 of the cylindrical member 60. The coupling portion 100 also includes the lateral recess 65, the chamfered surface 69 and the coupling pin 70.

As shown in FIG. 7, the drilling portion 80 has a smaller cutting diameter than the reaming portion 90, which allows the cutting head 14 to perform a rough cutting operation with the drilling portion 80 and a finish cutting operation with the reaming portion 90 without the need to change cutting tools.

As described above, the cutting tool of the invention has both a drilling portion and a reaming portion on the same cutting tool. As a result, the customer needs fewer cutting tools, thereby reducing manufacturing time, while achieving good surface finish and hole size qualities, as compared to conventional cutting tools.

The patents and publications referred to herein are hereby incorporated by reference.

Having described presently preferred embodiments the invention may be otherwise embodied within the scope of the appended claims.

1. A modular rotary cutting tool for conducting cutting operations on a work piece, comprising:
a tool shank having a pocket; and
a cutting head replaceably mounted in the pocket of the tool shank, the cutting head having a leading end and a trailing end opposite the leading end, the cutting head further comprising a drilling portion and a reaming portion,
wherein the drilling portion extends from the leading end of the modular rotary cutting tool to the reaming portion,
wherein the reaming portion extends from the drilling portion to a coupling portion of the cutting head,
wherein the reaming portion includes a chamfer, and
wherein the chamfer includes a chamfer primary relief surface and a chamfer secondary relief surface.

2. The modular rotary cutting tool according to claim 1, wherein the drilling portion includes a main cutting edge, a leading conical surface, a drill rake face, a drill back taper and a drill margin land.

3. The modular rotary cutting tool according to claim 1, wherein the chamfer primary relief surface is formed at an angle between 15 degrees and 80 degrees with respect to a longitudinal axis of the cutting head.

4. The modular rotary cutting tool according to claim 1, wherein the reaming portion includes a chamfer, a leading cutting edge with a back taper, a reamer rake face, a margin land and a leading cutting edge relief surface.

5. The modular rotary cutting tool according to claim 4, wherein the drilling portion has a smaller cutting diameter than the reaming portion.

6. The modular rotary cutting tool according to claim 1, wherein the coupling portion includes a cylindrical member, a chamfer extending between the cylindrical member and an end surface of the cylindrical member, a lateral recess, a chamfered surface and a coupling pin.

7. The modular rotary cutting tool according to claim 1, wherein the tool shank has an interlocking member arranged to retain the cutting head when the cutting head is installed within the pocket, at least one axial abutment surface abutting the cutting head when the cutting head is installed within the pocket, at least one driving surface arranged to rotate the cutting head when the shank is rotated with the cutting head installed within the pocket, and at least one vertically-angled retention surface located closer to the rotational axis than the at least one driving surface, and wherein the cutting head has an interlocking member for engaging the interlocking member of the shank, a cutting head abutment surface abutting the at least one abutment surface of the shank when the cutting head is installed within the pocket, a driven surface oriented to abut the driving surface of the shank when the cutting head is installed within the pocket, and at least one vertically-angled retention surface oriented to abut the at least one vertically-angled retention surface of the shank when the cutting head is installed within the pocket.

8. The modular rotary cutting tool according to claim 1, wherein the cutting head includes a lateral recess forming part of a flute, and the shank has a complementing lateral recess which continues the part of a flute formed in the cutting head in continuous and undistorted fashion when the cutting head is installed within the pocket of the shank.

9. The modular rotary cutting tool according to claim 1, wherein the pocket comprises a pair of wall sections, each wall section having the at least one driving surface, the at least one vertically-angled retention surface, and a radius blend extending between the vertically-angled retention surface and the at least one driving surface.

10. The modular rotary cutting tool according to claim 9, wherein each wall section further comprises at least one internally facing, generally cylindrical surface that project upwardly from a central floor portion.

11. The modular rotary cutting tool according to claim 9, further comprising an undercut between the at least one abutment surface and the at least one vertically-angled retention surface, the at least one driving surface and the radius blend.

12. A cutting head for a modular rotary cutting tool, comprising
a drilling portion; and
a reaming portion,
wherein the drilling portion extends from the leading end of the modular rotary cutting tool to the reaming portion,
wherein the reaming portion extends from the drilling portion to a coupling portion of the cutting head,
wherein the reaming portion includes a chamfer, and
wherein the chamfer includes a chamfer primary relief surface and a chamfer secondary relief surface.

13. The cutting head according to claim 12, wherein the drilling portion includes a main cutting edge, a leading conical surface, a drill rake face, a drill back taper and a drill margin land.

14. (canceled)

15. The cutting head according to claim 12, wherein the reaming portion includes a leading cutting edge with a back taper, a reamer rake face, a margin land and a leading cutting edge relief surface.

16. The cutting head according to claim 12, wherein the drilling portion has a smaller cutting diameter than the reaming portion.

17. The cutting head according to claim 12, wherein the coupling portion includes a cylindrical member, a chamfer extending between the cylindrical member and an end surface of the cylindrical member, a lateral recess, a chamfered surface and a coupling pin.

18. A cutting head for a modular rotary cutting tool, comprising
a drilling portion; and
a reaming portion,
wherein the drilling portion extends from the leading end of the modular rotary cutting tool to the reaming portion, and
wherein the reaming portion extends from the drilling portion to a coupling portion of the cutting head,
wherein the drilling portion includes a main cutting edge, a leading conical surface, a drill rake face, a drill back taper and a drill margin land,
wherein the reaming portion includes a chamfer, a leading cutting edge with a back taper, a reamer rake face, a margin land and a leading cutting edge relief surface, and
wherein the chamfer includes a chamfer primary relief surface and a chamfer secondary relief surface.

19. The cutting head according to claim 18, wherein the drilling portion has a smaller cutting diameter than the reaming portion.

20. The cutting head according to claim 18, wherein the coupling portion includes a cylindrical member, a chamfer extending between the cylindrical member and an end surface of the cylindrical member, a lateral recess, a chamfered surface and a coupling pin.
